(19) United States
(12) Patent Application Publication
(10) Pub. No.: US 2007/0046714 A1
(43) Pub. Date: Mar. 1, 2007

(54) Method of detecting a state of a printhead and an image forming apparatus using the same

(75) Inventors: O-hyun Beak, Seoul (KR); Young-bok Ju, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/471,501

(22) Filed: Jun. 21, 2006

(30) Foreign Application Priority Data
Aug. 24, 2005 (KR) 2005-78019

(51) Int. Cl. B41J 29/393

(52) U.S. Cl. 347/19

(57) ABSTRACT

A method of detecting a state of a printhead and an image forming apparatus using the same. The image forming apparatus includes a power supply unit to generate power, a printhead unit having a plurality of heaters to generate heat according to a respective plurality of heat driving signals, a head board unit to transfer the generated power to the printhead unit and to generate the respective plurality of heat driving signals according to a nozzle control signal, and a controller to generate the nozzle control signal containing driving information of the plurality of heaters, to output the generated nozzle control signal to the head board unit, and to detect whether the respective heaters are in a normal state using information about a current flowing between the power supply unit and the head board unit. Accordingly, states of the heaters that generate ink bubbles can be detected without removing a power stabilizing capacitor embedded in a cartridge of the image forming apparatus and a detection function can be implemented in the image forming apparatus.

### CROSS-REFERENCE TO RELATED APPLICATIONS

This application claims the benefit of Korean Patent Application No. 10-2005-0078019, filed on Aug. 24, 2005, in the Korean Intellectual Property Office, the disclosure of which is incorporated herein in its entirety by reference.

### BACKGROUND OF THE INVENTION

1. Field of the Invention

The present general inventive concept relates to a method of detecting a state of a printhead and an image forming apparatus using the same, and more particularly, to a method of detecting a state of a printhead by detecting states of heaters that generate ink bubbles without removing a power stabilizing capacitor embedded in a cartridge of an inkjet type image forming apparatus, and an image forming apparatus using the same.

2. Description of the Related Art

An inkjet printhead includes a plurality of heaters generating heat for ejecting ink from ink ejection nozzles formed in the printhead. Each heater is composed of a resistor, and if the resistor is in an open circuit state or a short-circuit state, a printer cannot control the ink ejection nozzles to eject ink properly, resulting in a decrease in print quality and/or a malfunction of the printer in more serious cases.

There are three conventional methods of detecting missing or defective nozzles. In the first conventional method, a predetermined test pattern is printed and missing nozzles are detected using a predetermined test device scanning the printed test pattern. In the second conventional method, light is projected to locations to which ink is ejected from nozzles, and it is determined whether the projected light passes through the locations. If it is determined that the light passes through the locations, the nozzles are detected as missing nozzles.

In the conventional third method, it is determined whether the heaters that generate the ink bubbles are damaged by using a separate test device and power supply. That is, after removing a head driving power supply, a separate power supply is installed, a test resistor is placed between the separate power supply and one of the heaters. Accordingly, it is determined whether the heater is damaged by measuring a voltage across the test resistor by voltage dividing the heater and the test resistor, which are connected in series, and comparing the measured voltage to a predetermined reference voltage.

However, the first conventional method is inconvenient due to requirements of using test printing and a test device, and moreover, the test device is expensive. Likewise, the second conventional method is expensive, since a device scanning and detecting light is necessary, and an accurate light scan controlling method is required. The third conventional method is also inconvenient, since (1) before performing the testing, the head driving power supply must be removed and the separate power supply must be installed, and (2) after testing the separate power supply must be removed and the head driving power supply must be installed again. Furthermore, additional components, such as a separate power driver and a comparator, are required to detect the state of the printhead.

Furthermore, a power stabilizing capacitor is embedded in the printhead or a head board of an image forming apparatus having the printhead including a plurality of ink ejection nozzles and heaters. In this case, it is difficult to use the third conventional method to measure a voltage variation due to the embedded capacitor.

### SUMMARY OF THE INVENTION

The present general inventive concept provides a method of detecting a state of a printhead by detecting states of heaters in the printhead that generate ink bubbles without removing a power stabilizing capacitor embedded in a cartridge of an inkjet type image forming apparatus, and an image forming apparatus using the same.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming apparatus capable of detecting a state of a printhead installed therein, the apparatus including a power supply unit to generate power, a printhead unit having a plurality of heaters to generate heat according to a respective plurality of heat driving signals, a head board unit to transfer the power from the power supply unit to the printhead unit and to generate the respective plurality of heat driving signals according to a nozzle control signal, and a controller to generate the nozzle control signal containing driving information of the plurality of heaters, to output the generated nozzle control signal to the head board unit, and to detect whether the plurality of heaters are in a normal state using information about a current flowing between the power supply unit and the head board unit.

The head board unit may include a control signal decoder to generate the heat driving signals according to the nozzle control signal and to output the generated heat driving signals to the printhead unit, a power relay unit to transfer the power generated by the power supply unit to the printhead unit, and a current information detector to detect a current flowing between a ground terminal of the power relay unit and a ground terminal of the power supply unit and to output the detected current to the controller as current information.

The printhead unit may include a plurality of field effect transistors (FETs), each controlling a current flowing between a drain thereof and a source thereof according to a corresponding one of the heat driving signals which is input to a gate thereof, and a corresponding one of the heaters connected to the drain or the source of each FET generates heat according to an amount of the current flowing between the drain and source of the corresponding FET to generate ink bubbles.

The head board unit may include a capacitor to stabilize the power transferred to the printhead unit.

The current information detector may include a measurement resistor positioned between the ground terminal of the power relay unit and the ground terminal of the power supply unit, and a voltage converter to convert a current flowing through the measurement resistor to a voltage and to output the converted voltage to the controller as the current information.

The voltage converter may amplify the converted voltage and output the amplified voltage to the controller as the current information. The voltage converter may include an operational amplifier (OP AMP) connected to the both ends of the measurement resistor.

The controller may generate the nozzle control signal to sequentially drive the heaters and determine that a heater that is currently being driven is in an abnormal state based on the current information, if the current flowing between the ground terminals of the power supply unit and the power relay unit is lower than a predetermined reference current. The controller may group the heaters in groups, generate the nozzle control signal to drive the plurality of heaters group by group, and determine that at least one of heaters included in a group that is currently being driven is in an abnormal state based on the current information, if the current flowing between the ground terminals of the power supply unit and the power relay unit is lower than the predetermined reference current. The controller may generate the nozzle control signal to sequentially increase a number of the heaters being driven in each group and determine using the current information whether a heater that is added to the group of heaters that is currently being driven is in the abnormal state by comparing a variation amount of the current flowing between the ground terminals of the power supply unit and the power relay unit to the predetermined reference current.

The printhead unit may control a duration of each heat driving signal for heat generation or the transferred power so that each heater generates an amount of heat that is not sufficient to eject ink.

The foregoing and/or other aspects of the present general inventive concept are also achieved by providing an image forming apparatus, including a printhead having a plurality of heaters with heating resistances and a plurality of switches to draw current through the corresponding heating resistances when the switches are turned on, a power supply unit to supply a power to operate the printhead and having a first local ground, and a head board to drive the printhead. The head board includes a power relay unit to receive the supplied power and to provide the supplied power to each of the heating resistances in the printhead, the power relay unit having a second local ground, a measurement resistance coupled between the first and second local grounds to be connected to each of the heating resistances in the printhead in series, and a current detector to determine whether a selected one or more of the heaters function properly when a corresponding one or more of the switches is turned on by measuring one or more currents flowing through a corresponding one or more of the heat resistances of the selected heaters.

The foregoing and/or other aspects of the present general inventive concept are also achieved by providing an image forming apparatus, including a printhead having a plurality of heaters, a power supply to supply power to operate the heaters, at least one capacitor to be charged by the power supply before driving the heaters, a measurement resistor disposed between the power supply and the heaters, a controller to selectively drive one or more of the heaters such that the supplied power is dissipated by the selectively driven heaters and the measurement resistor in series and to detect a current flowing through the measurement resistor to determine whether the selectively driven heaters operate normally in an abnormal mode.

The foregoing and/or other aspects of the present general inventive concept are also achieved by providing an image forming apparatus, including a printhead having a plurality of heaters arranged in parallel to receive a power supply and to dissipate a first portion of the power supply when the heaters are turned on, and a head board having a measurement resistor connected in series with each of the heaters to dissipate a second portion of the power supply when the heaters are turned on such that a selected one or more of the heaters is tested by turning on the selected one or more heaters and measuring current dissipated through the measurement resistor.

The foregoing and/or other aspects of the present general inventive concept are also achieved by providing an image forming apparatus, including a power supply unit to generate power, a printhead unit having a plurality of heaters operated by the generated power, a controller to drive at least one heater in the printhead unit between a testing mode and an ink ejection mode, and a current information detector having a resistor connected between the power supply unit and the printhead unit to determine a current that flows through the resistor to indicate whether the at least one driven heater is operating properly when the controller operates the printhead unit in the testing mode.

The foregoing and/or other aspects of the present general inventive concept are also achieved by providing a method of detecting a state of a printhead of an image forming apparatus having a power supply unit to generate power and a head board unit to relay the generated power and to generate a plurality of heater driving signals, the method including generating the power, generating each of the heater driving signals to respectively drive a plurality of heaters in the printhead, driving each of the heaters according to the heater driving signals, and detecting a state of each of the heaters using information about a current flowing between the power supply unit and the head board unit.

The generating of each of the heater driving signals to respectively drive the plurality of heaters may include generating a nozzle control signal containing state information of the heaters, and generating the heater driving signals using the generated nozzle control signal.

The image forming apparatus may include a capacitor embedded in the head board unit to stabilize the power generated in the power generation operation. The generating of each of the heater driving signals to respectively drive the plurality of heaters may be performed after being delayed by a time it takes to charge the capacitor after the generation of power.

The detecting of the state of each of the heaters using the information about the current flowing between the power supply unit and the head board unit may include detecting a current flowing through a measurement resistor placed between a ground terminal of the power supply unit and a ground terminal of the head board unit, converting the detected current to a voltage and generating the converted voltage as current information, and detecting a state of each of the heaters using the current information.

The converting of the detected current to the voltage and the generating of the converted voltage as the current information may include amplifying the converted voltage and generating the amplified voltage as the current information.

The generating of the nozzle control signal containing state information of the heaters may include generating the nozzle control signal to sequentially drive the heaters, and the generating of the heat driving signals using the generated nozzle control signal, the driving of each of the heaters according to the heater driving signals, and the detecting of the state of each of the heaters using information about the current flowing between the power supply unit and the head board unit may be repeatedly performed until all states of the heaters are detected.

The detecting of the state of each of the heaters using the current information may include using the current information to determine that a heater that is currently being driven is in an abnormal state if the current flowing between the power supply unit and the head board unit is lower than a predetermined reference current.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating an image forming apparatus that detects a state of a printhead according to an embodiment of the present general inventive concept;

FIG. 2 is a detailed block diagram illustrating a head board unit illustrated of the image forming apparatus of FIG. 1, according to an embodiment of the present general inventive concept;

FIG. 3 is a circuit diagram illustrating a part of the image forming apparatus of FIG. 1, according to an embodiment of the present general inventive concept;

FIGS. 4A and 4B are waveform diagrams illustrating a heater driving signal and a current flowing through a measurement resistor in the image forming apparatus of FIG. 3;

FIG. 5 is a schematic equivalent circuit diagram illustrating a power supply unit, a power relay unit, and a printhead unit, according to an embodiment of the present general inventive concept; and

FIG. 6 is a flowchart illustrating a method of detecting a state of a printhead and an operation of an image forming apparatus using the same, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

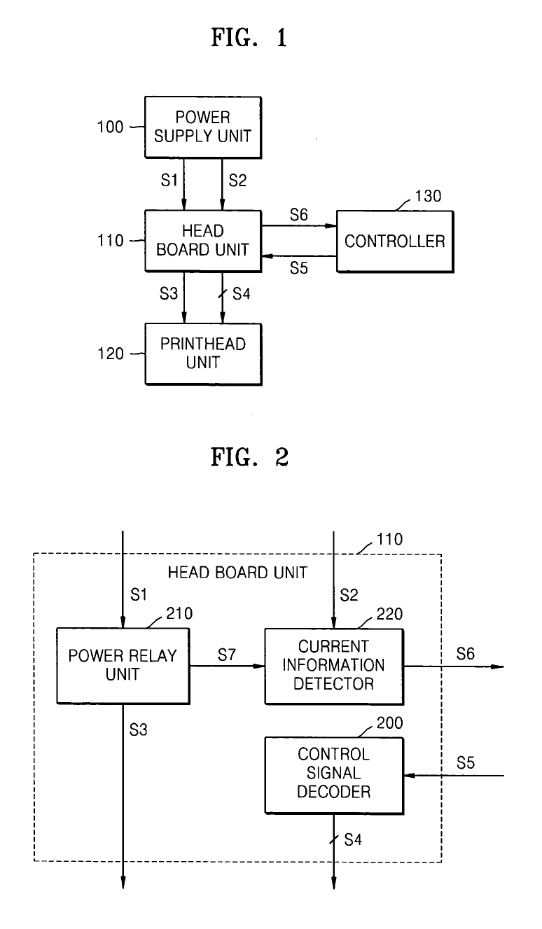

FIG. 1 is a block diagram illustrating an image forming apparatus that detects a state of a printhead according to an embodiment of the present general inventive concept. The image forming apparatus of the present embodiment includes a power supply unit 100, a head board unit 110, a printhead unit 120, and a controller 130.

Referring to FIG. 1, the power supply unit 100 generates power to drive the image forming apparatus using alternating current (AC) power and supplies the generated power to each component in the image forming apparatus.

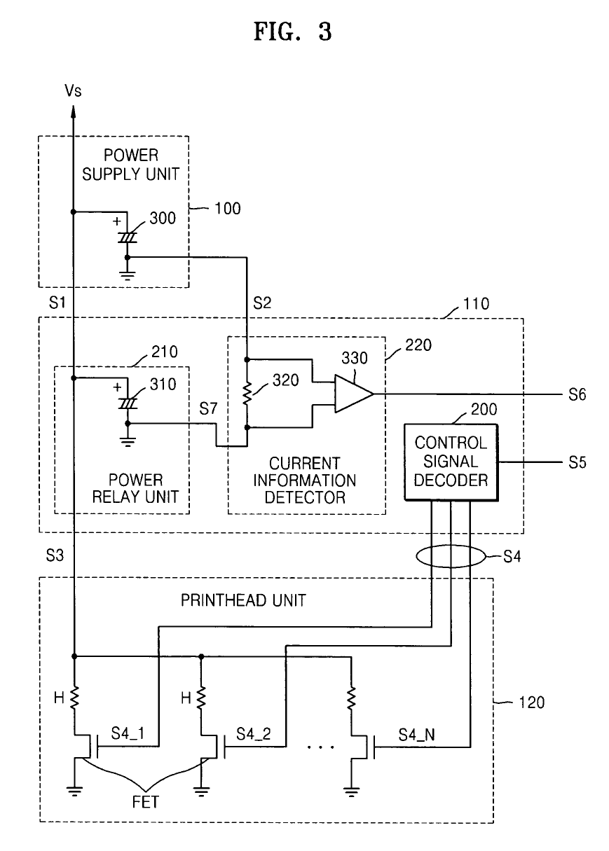

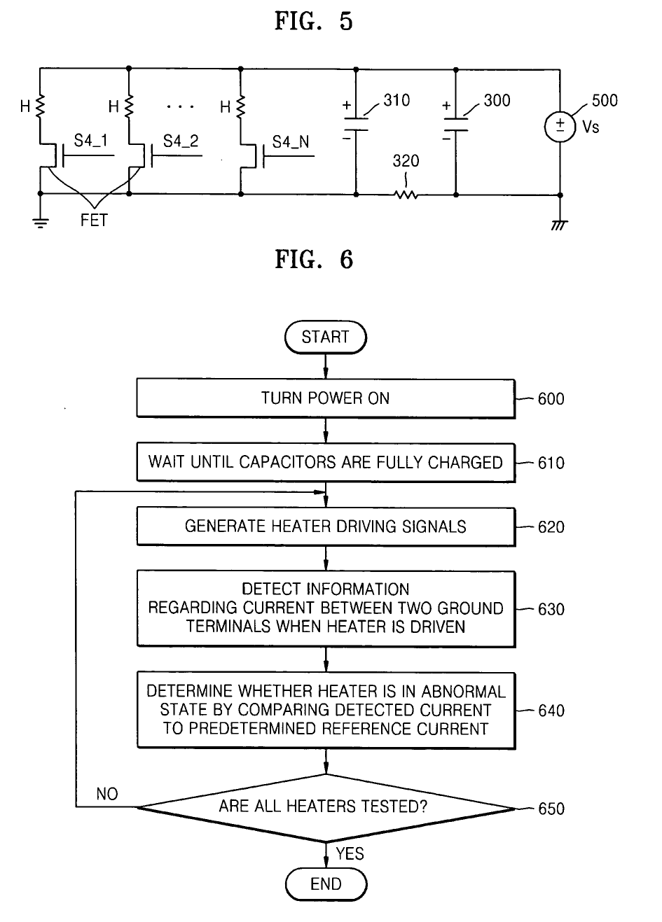

The printhead unit 120 includes “N” heaters H (see FIGS. 3 and 5) and forms ink bubbles in ink ejection nozzles by generating heat according to control from the controller 130. The control from the controller 130 is a nozzle control signal S5 containing states and driving times of the “N” heaters H. That is, the nozzle control signal S5 is decoded into “N” heater driving signals S4 by the head board unit 110 and output to the printhead unit 120. That is, heat generation of the “N” heaters H installed in the printhead unit 120 is determined based on the “N” heater driving signals S4.

As described above, the head board unit 110 generates the “N” heater driving signals S4 using the nozzle control signal S5 received from the controller 130 and outputs the generated “N” heater driving signals S4 to the printhead unit 120. In addition, the head board unit 110 receives power S1 generated by the power supply unit 100 and outputs power S3 to drive the printhead unit 120. The head board unit 110 also measures a current flowing between a predetermined node S2 of the power supply unit 100 and the head board unit 110 and outputs the measured result to the controller 130 as current information S6.

The controller 130 not only generates the nozzle control signal S5 as described above, but also determines whether each heater H is in an abnormal state by using the current information S6 received from the head board unit 110. The controller 130 may determine by referring to the current information S6 whether each heater H is in the abnormal state to determine that (1) the heater H is damaged in an open-circuit state or (2) misoperation of a switching component, such as an FET to drive the heater H, occurs if the current flowing between the power supply unit 100 and the head board unit 110 is lower than a predetermined reference current by referring to the current information S6. Here, it is determined in principle that the heater H is in the abnormal state when the current flowing between the power supply unit 100 and the head board unit 110 is 0. However, the predetermined reference current can be set to other values (beside 0) considering a measurement error of the measured current and driving states of a plurality of heaters H.

The states of the respective heaters H can be stored in a memory embedded in the controller 130 or the image forming apparatus and can be used for a missing or malfunctioning nozzle compensation algorithm.

FIG. 2 is a detailed block diagram illustrating the head board unit 110. The head board unit 110 includes a control signal decoder 200, a power relay unit 210, and a current information detector 220.

Referring to FIGS. 1 and 2, the control signal decoder 200 generates the “N” heater driving signals S4 using the nozzle control signal S5 received from the controller 130 and outputs the generated “N” heater driving signals S4 to the printhead unit 120. In particular, the control signal decoder 200 generates the “N” heater driving signals S4 using heater address information and a series of driving sequences contained in the nozzle control signal S5.

The power relay unit 210 transfers the power S3 to drive the printhead unit 120 to the printhead unit 120 using the power S1 input from the power supply unit 100.

The current information detector 220 detects a current flowing between a ground terminal S7 of the power relay unit 210 and a ground terminal S2 of the power supply unit 100 and outputs the detected result to the controller 130 as the current information.

FIG. 3 is a circuit diagram illustrating a part of the image forming apparatus according to an embodiment of the present general inventive concept, except that FIG. 3 does not illustrate the controller 130.

Referring to FIG. 3, capacitors 300 and 310 are included in the power supply unit 100 and the power relay unit 210, respectively, to supply stable power. A voltage Vs is applied in the power supply unit 100 when the image forming apparatus is turned on. When the image forming apparatus is turned on and the capacitors 300 and 310 are fully charged to Vs, an image forming operation or an operation of detecting a state of a printhead (i.e., the printhead unit 120) can be performed.

A measurement resistor 320 is placed between the ground terminal S2 of the power supply unit 100 and the ground terminal S7 of the power relay unit 210. The current information S6 about a current flowing through the measurement resistor 320 is provided to the controller 130. Either a method of providing a current value or a method of providing a voltage value converted from the current value can be used to provide the current information S6 to the controller 130. As illustrated in FIG. 3, since a negative terminal and a positive terminal (i.e., both input terminals) of an OP AMP 330 are connected to the both ends of the measurement resistor 320, the output S6 of the OP AMP 330 is provided to the controller 130 by amplifying the voltage across the measurement resistor 320. The controller 130 receives the amplified voltage as the current information S6, compares the received voltage to the predetermined reference voltage, and determines that a heater H currently driven is in an abnormal state if the received voltage is lower than the predetermined reference voltage. In another method, the controller 130 calculates the current flowing through the measurement resistor 320 based on the received voltage, the resistance of the measurement resistor 320, and a gain of the OP AMP 330, compares the calculated current to the predetermined reference current, and determines that the heater H that is currently being driven is in the abnormal state if the calculated current is lower than the predetermined reference current.

The printhead unit 120 includes “N” FETs having a switching function and the “N” heaters H (e.g., heating resistors). The “N” heater driving signals S4_1 through S4_N are applied to respective gates of the “N” FETs. An amount of a current flowing between a drain and a source of each FET varies according to each value of the “N” heater driving signals S4_1 through S4_N. That is, the amount of current flowing through each heater H is determined according to each value of the “N” heater driving signals S4_1 through S4_N.

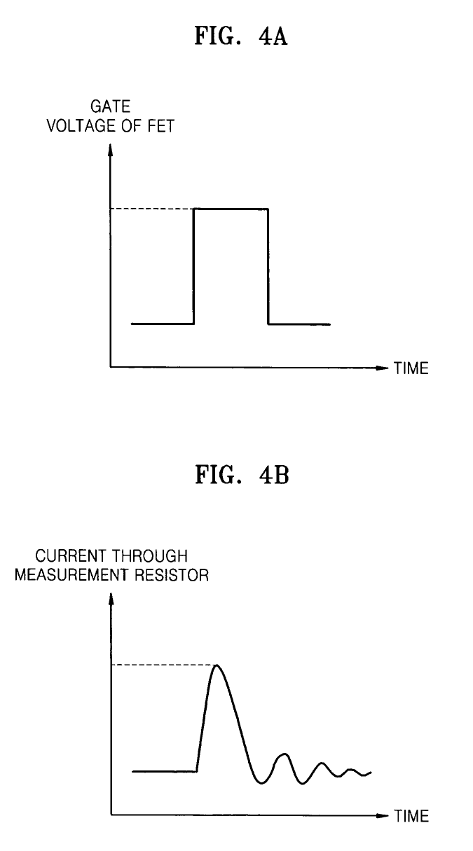

FIGS. 4A and 4B are waveform diagrams illustrating one of the heater driving signals S4_1 through S4_N and the current flowing through the measurement resistor 320.

FIG. 4A is a waveform illustrating a heater driving signal S4_n input to the gate of one of the “N” FETs. When a value of the heater driving signal S4_n is high (i.e., when the value of the heater driving signal S4_n is higher than a predetermined voltage value) a corresponding heater H is operated.

FIG. 4B is a waveform illustrating the current flowing through the measurement resistor 320 when the heater driving signal S4_n is applied, the waveform having a ripple pattern. Referring to FIGS. 3 and 4B, the ripple pattern is generated by the capacitors 300 and 310 and various resistance components. The controller 130 can use various methods to determine whether a heater H is in the abnormal state using the waveform illustrated in FIG. 4. For example, a method of determining that the heater H that is currently being driven is in the abnormal state if a maximum value of a first ripple is lower than the predetermined reference current value may be used. In another example, a method of integrating the waveform for a predetermined time and determining whether the heater H that is currently being driven is in the abnormal state using an energy value can also be used. Additionally, states of the “N” heaters H can be detected according to a manner in which the heater driving signals S4 are applied. Examples in this regard are as follows.

The controller 130 generates the nozzle control signal S5 to sequentially drive the “N” heaters H and to determine that the heater H that is currently being driven is in the abnormal state if, based on the current information S6, the current flowing between the two ground terminals (i.e., S2 of the power supply unit 100 and S7 of the power relay unit 210) is lower than the predetermined reference current. That is, the waveform illustrated in FIG. 4B is generated by driving one heater H. However, in this case, since a current measured by driving one heater H may be too small to generate an error, a method of grouping heaters H and simultaneously driving heaters H in the same group can be used. That is, the controller 130 classifies the “N” heaters H in groups of “M” heaters H (i.e., “M” heaters H in each group), generates the nozzle control signal S5 to drive the “N” heaters H group by group, and determines that at least one of the heaters H belonging to a group that is currently being driven is in the abnormal state if the current flowing between the two ground terminals (i.e., S2 of the power supply unit 100 and S7 of the power relay unit 210) is lower than the predetermined reference current using the current information S6.

In another method, the controller 130 generates the nozzle control signal S5 to sequentially increase the number of heaters H driven in each group and determines that a heater H is in the abnormal state by comparing a variation amount of the current flowing between the two ground terminals (i.e., S2 of the power supply unit 100 and S7 of the power relay unit 210) to the predetermined reference current value using the current information S6. That is, if the current variation amount is greater than the predetermined reference current value, the controller 130 determines that a heater H that is newly added to the group of heaters H that is currently being driven is in a normal state. The predetermined reference current value may be set close to zero, since the current that flows through the measuring resistor 320 is close to zero when the heater H is in an open-circuit state. It should be understood that although several exemplary methods of detecting a state of the printhead (i.e., the printhead unit 120) have been described above, these examples are not intended to limit the scope of the present general inventive concept. Other methods may also be used to detect the states.

Heat is generated according to the amount of a current flowing through each heater H, and ink bubbles can be generated due to the heat. However, since the ink bubbles used to eject ink do not have to be generated in order to detect a heater state, each heater H may generate an amount of thermal energy that is not sufficient to generate the ink bubbles. More specifically, the amount of thermal energy can be controlled by, for example, controlling a duration or interval of a high level of each of the heater driving signals S4_1 through S4_N or the voltage S3 applied to the heaters H.

FIG. 5 is a schematic equivalent circuit diagram illustrating the power supply unit 100, the power relay unit 210, and the printhead unit 120 according to an embodiment of the present general inventive concept.

Referring to FIG. 5, the power supply unit 500 supplies the voltage of Vs (same as the voltage Vs of FIG. 3) to the circuit illustrated in FIG. 5. The capacitors 300 and 310 are charged by the supplied voltage so that stable power is supplied to circuits such as the heaters H. When the capacitors 300 and 310 are fully charged, a voltage equilibrium is achieved, and therefore a current does not flow unless any FET is switched on by the heater driving signals S4_1 through S4_N. That is, the current flowing through the measurement resistor 320 is theoretically 0 initially when the voltage equilibrium is obtained. If at least one of the heater driving signals S4_1 through S4_N is high as illustrated in FIG. 4A, a current flows through a corresponding heater H (i.e., a corresponding resistor illustrated in FIG. 5). Accordingly, the current flowing through the measurement resistor 320 also varies as illustrated in FIG. 4B. If the current is converted to a voltage value and amplified by the OP AMP 330 and provided to the controller 130 as the current information S6, the controller 130 can determine whether the at least one heater H that is currently being driven by the heater driving signals S4_1 through S4_N is in the abnormal state based on the amplified voltage. That is, when the nozzle control signal S5 is generated to drive only one heater H, if the current flowing through the measurement resistor 320 is lower than a predetermined value (i.e., the predetermined reference current value) based on the measured current information S6, it is determined that the heater H that is currently being driven is in an open-circuit state (i.e., the abnormal state) and therefore the current does not flow. That is, the open-circuit state of the heater state can be determined. It should be understood that the measurement resistor 320 can be any device having a predetermined resistance that is suitable for measuring current and/or voltage therethrough by forming a voltage divider with one or more of the heaters H that are powered on.

FIG. 6 is a flowchart illustrating a method of detecting a state of a printhead and an operation of an image forming apparatus using the same according to an embodiment of the present general inventive concept. The method of FIG. 6 may be performed by the image forming apparatus of FIG. 1. Accordingly, for illustration purposes, the method of FIG. 6 is described below with reference to FIGS. 1 through 5.

It can be assumed that the heater driving signals S4 are set to sequentially drive the heaters H.

Referring to FIGS. 1 to 6, the power supply unit 100 generates the power S1 to drive the image forming apparatus in operation 600. The power supply unit 100 can generate the power when the image forming apparatus is turned on and the voltage Vs is applied to the power supply unit 100.

The image forming apparatus includes the capacitors 300 and 310 to stabilize the power S1, and the image forming apparatus waits until the capacitors 300 and 310 are fully charged (e.g., to the voltage Vs) in operation 610.

The head board unit 110 generates the heater driving signals S4 to drive the “N” heaters H installed in the printhead unit 120 and drives one of the “N” heaters H to heat according to the generated heater driving signals S4 in operation 620. In detail, the nozzle control signal S5 is generated by the controller 130, and the heater driving signals S4 are generated by the head board unit 110 using the generated nozzle control signal S5.

The current information S6 regarding the current flowing between the power supply unit 100 and the head board unit 110 is detected in operation 630.

It is determined whether the current flowing through the measurement resistor 320 is lower than the predetermined reference current based on the detected current information S6. If it is determined that the current flowing through the measurement resistor 320 is lower than the predetermined reference current (e.g., which may be close to 0), it is determined that the heater H that is currently being driven is in the open-circuit state (i.e., in the abnormal state) in operation 640. As described above, when the heater H is in the open circuit state, the current flowing through the measurement resistor 320 should be zero.

The controller 130 determines whether states of all the heaters H in the printhead unit 120 are detected in operation 650. If the controller 130 determines that the states of all the heaters H in the printhead unit 120 are detected, the controller 130 ends a heater state detection process (i.e., the method of FIG. 6). If it is determined that any heater H having a state that has not yet been detected remains, the heater state detection process returns to the operation 620, controlling the nozzle control signal S5 and driving the remaining heater H.

A method of driving the heaters H in the printhead unit 120, group by group, and a method of increasing the number of heaters H that are sequentially driven in each group can be implemented in a similar manner as the method of FIG. 6.

The head board unit 120 may be a printhead driving unit.

The general inventive concept can also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains.

As described above, according to embodiments of the present general inventive concept, a damage of a printer system and/or low print quality due to a malfunction of a printhead can be prevented from occurring by detecting a state of the printhead. In particular, an open-circuit state of a heater H of the printhead and detected information can be used for a missing or malfunctioning nozzle compensation algorithm.

In addition, complicated parts (e.g., separate power supplies and/or light emitting/detecting parts) are not necessary to detect an open-circuit state of a printhead, and a detection function of the present general inventive concept can be embedded in image forming apparatuses, thereby allowing a user to easily detect a state of the printhead.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus capable of detecting a state of a printhead installed therein, the apparatus comprising:
a power supply unit to generate power;
a printhead unit having a plurality of heaters to generate heat according to a respective plurality of heat driving signals;
a head board unit to transfer the power from the power supply unit to the printhead unit and to generate the respective plurality of heat driving signals according to a nozzle control signal; and
a controller to generate the nozzle control signal containing driving information of the plurality of heaters, to output the generated nozzle control signal to the head board unit, and to detect whether the plurality of heaters are in a normal state using information about a current flowing between the power supply unit and the head board unit.

2. The apparatus of claim 1, wherein the head board unit comprises:
a control signal decoder to generate the heat driving signals according to the nozzle control signal and to output the generated heat driving signals to the printhead unit;
a power relay unit to transfer the power generated by the power supply unit to the printhead unit; and
a current information detector to detect a current flowing between a ground terminal of the power relay unit and a ground terminal of the power supply unit and to output the detected current to the controller as current information.

3. The apparatus of claim 1, wherein the printhead unit includes a plurality of field effect transistors (FETs), each controlling a current flowing between a drain thereof and a source thereof according to a corresponding one of the heat driving signals which is input to a gate thereof, and a corresponding one of the heaters connected to the drain or the source of each FET generates heat according to an amount of the current flowing between the drain and the source of the FET to generate ink bubbles.

4. The apparatus of claim 1, wherein the head board unit includes a capacitor to stabilize the power transferred to the printhead unit.

5. The apparatus of claim 2, wherein the current information detector comprises:
a measurement resistor positioned between the ground terminal of the power relay unit and the ground terminal of the power supply unit; and
a voltage converter to convert the current flowing through the measurement resistor to a voltage and to output the converted voltage to the controller as the current information.

6. The apparatus of claim 5, wherein the voltage converter amplifies the converted voltage and outputs the amplified voltage to the controller as the current information.

7. The apparatus of claim 5, wherein the voltage converter includes an operational amplifier (OP AMP) connected to the both ends of the measurement resistor.

8. The apparatus of claim 2, wherein the controller generates the nozzle control signal to sequentially drive the heaters and determines that a heater that is currently being driven is in an abnormal state based on the current information, if the current flowing between the ground terminals of the power supply unit and the relay power unit is lower than a predetermined reference current.

9. The apparatus of claim 2, wherein the controller groups the plurality of heaters into groups of heaters, generates the nozzle control signal for driving the plurality of heaters group by group, and determines that at least one of heaters included in a group of heaters that is currently being driven is in an abnormal state based on the current information, if the current flowing between the ground terminals of the power supply unit and the relay power unit is lower than a predetermined reference current.

10. The apparatus of claim 9, wherein the controller generates the nozzle control signal to sequentially increase a number of the heaters driven in each group of heaters and determines using the current information whether a heater that is added to the group of heaters that is currently being driven is in the abnormal state by comparing a variation amount of the current flowing between the ground terminals of the power supply unit and the power relay unit to the predetermined reference current.

11. The apparatus of claim 3, wherein the printhead unit controls a duration of each heat driving signal for heat generation or the transferred power so that each heater generates an amount of heat that is not sufficient to eject ink.

12. An image forming apparatus, comprising:
a printhead including a plurality of heaters having heating resistances and a plurality of switches to draw current through the corresponding heating resistances when the switches are turned on;
a power supply unit to supply a power to operate the printhead and having a first local ground; and
a head board to drive the printhead including a power relay unit to receive the supplied power and to provide the supplied power to each of the heating resistances in the printhead, the power relay unit having a second local ground, a measurement resistance coupled between the first and second local grounds to be connected to each of the heating resistances in the printhead in series, and a current detector to determine whether a selected one or more of the heaters function properly when a corresponding one or more of the switches is turned on by measuring one or more currents flowing through a corresponding one or more of the heat resistances of the selected heaters.

13. The apparatus of claim 12, wherein the power supply unit and the power relay unit comprise first and second capacitors to stabilize the supplied power, and the power supply unit receives a predetermined voltage when the apparatus is turned on such that the first and second capacitors are charged to the predetermined voltage.

14. An image forming apparatus, comprising:
a printhead having a plurality of heaters;
a power supply to supply power to operate the heaters;
at least one capacitor to be charged by the power supply before driving the heaters;
a measurement resistor disposed between the power supply and the heaters;
a controller to selectively drive one or more of the heaters such that the supplied power is dissipated by the selectively driven heaters and the measurement resistor in series and to detect a current flowing through the measurement resistor to determine whether the selectively driven heaters operate normally in an abnormal mode.

15. The apparatus of claim 14, wherein if the current flowing through the measurement resistor is close to zero, the controller determines that the selectively driven heaters are operating in the abnormal mode.

16. An image forming apparatus, comprising:
a printhead having a plurality of heaters arranged in parallel to receive a power supply and to dissipate a first portion of the power supply when the heaters are turned on; and
a head board having a measurement resistor connected in series with each of the heaters to dissipate a second portion of the power supply when the heaters are turned on such that a selected one or more of the heaters is tested by turning on the selected one or more heaters and measuring current dissipated through the measurement resistor.

17. An image forming apparatus, comprising:
a power supply unit to generate power;
a printhead unit having a plurality of heaters operated by the generated power;
a controller to drive at least one heater in the printhead unit between a testing mode and an ink ejection mode; and
a current information detector having a resistor connected between the power supply unit and the printhead unit to determine a current that flows through the resistor to indicate whether the at least one driven heater is operating properly when the controller operates the printhead unit in the testing mode.

18. The apparatus of claim 17, wherein the at least one heater is determined to operate properly when the at least one driven heater serves as an effective resistance allowing current to flow, and the at least one driven heater is determined to malfunction when the at least one driven heater is an open circuit.

19. A method of detecting a state of a printhead of an image forming apparatus having a power supply unit to generate power and a head board unit to relay the generated power and to generate a plurality of heater driving signals, the method comprising:
generating the power;
generating each of the heater driving signals to respectively drive a plurality of heaters in the printhead;
driving each of the heaters according to the heater driving signals; and
detecting a state of each of the heaters using information about a current flowing between the power supply unit and the head board unit.

20. The method of claim 19, wherein the generating of each of the heater driving signals comprises:
generating a nozzle control signal containing state information of the heaters; and
generating the heater driving signals using the generated nozzle control signal.

21. The method of claim 19, wherein the image forming apparatus has a capacitor embedded in the head board unit to stabilize the power generated in the power generation operation, and the generating of each of the heater driving signals is performed after being delayed by a time it takes to charge the capacitor after the generation of the power.

22. The method of claim 19, wherein the detecting of the state of each of the heaters using the information about the current flowing between the power supply unit and the head board unit comprises:
detecting a current flowing through a measurement resistor placed between a ground terminal of the power supply unit and a ground terminal of the head board unit;
converting the detected current to a voltage and generating the converted voltage as current information; and
detecting a state of each of the heaters using the current information.

23. The method of claim 22, wherein the converting of the detected current to the voltage and the generating of the converted voltage as the current information comprises amplifying the converted voltage and generating the amplified voltage as the current information.

24. The method of claim 20, wherein the generating of the nozzle control signal containing state information of the heaters comprises generating the nozzle control signal to sequentially drive the heaters, and the generating of the heater driving signals using the generated nozzle control signal, the driving of each of the heaters according to the heater driving signals, and the detecting of the state of each of the heaters using the information about the current flowing between the power supply unit and the head board unit are repeatedly performed until all states of the heaters are detected.

25. The method of claim 24, wherein the detecting of the state of each of the heaters using the current information comprises using the current information to determine that a heater that is currently being driven is in an abnormal state if the current flowing between the power supply unit and the head board unit is lower than a predetermined reference current.

26. A computer readable recording medium having recorded thereon a computer readable program to perform a method of detecting a state of a printhead of an image forming apparatus having a power supply unit to generate power and a head board unit to relay the generated power and to generate a plurality of heater driving signals, the method comprising:
generating the power;
generating each of the heater driving signals to respectively a plurality of heaters in the printhead;
driving each of the heaters according to the heater driving signals; and
detecting a state of each of the heaters using information about a current flowing between the power supply unit and the head board unit.

27. The method of claim 26, wherein the generating of each of the heater driving signals comprises:
generating a nozzle control signal containing state information of the heaters; and
generating the heater driving signals using the generated nozzle control signal.

28. The method of claim 26, wherein the image forming apparatus has a capacitor embedded in the head board unit to stabilize the power generated in the power generation operation, and the generating of each of the heater driving signals is performed after being delayed by a time it takes to charge the capacitor after the generation of the power.

29. The method of claim 26, wherein the detecting of the state of each of the heaters using the information about the current flowing between the power supply unit and the head board unit comprises:
detecting a current flowing through a measurement resistor placed between a ground terminal of the power supply unit and a ground terminal of the head board unit;
converting the detected current to a voltage and generating the converted voltage as current information; and
detecting a state of each of the heaters using the current information.

30. The method of claim 29, wherein the converting of the detected current to the voltage and the generating of the converted voltage as the current information comprises amplifying the converted voltage and generating the amplified voltage as the current information.

31. The method of claim 27, wherein the generating of the nozzle control signal containing state information of the heaters comprises generating the nozzle control signal to sequentially drive the heaters, and the generating of the heater driving signals using the generated nozzle control signal, the driving of each of the heaters according to the heater driving signals, and the detecting of the state of each of the heaters using the information about the current flowing between the power supply unit and the head board unit are repeatedly performed until all states of the heaters are detected.

32. The method of claim 31, wherein the detecting of the state of each of the heaters using the current information comprises using the current information to determine that a heater that is currently being driven is in an abnormal state if the current flowing between the power supply unit and the head board unit is lower than a predetermined reference current.
